(19) United States
(12) Patent Application Publication
(10) Pub. No.: US 2016/0218912 A1
(43) Pub. Date: Jul. 28, 2016

(54) QUALITY OF EXPERIENCE AWARE TRANSPORT SELF ORGANIZING NETWORK FRAMEWORK

(71) Applicant: NOKIA SOLUTIONS AND NETWORKS OY, Espoo (FI)

(72) Inventors: Zoltan VINCZE, Kormend (HU); Lajos BAJZIK, Skekesfehervar (HU); Csaba DEAK, Budapest (HU); Tamas KARASZ, Sopron (HU); Csaba VULKAN, Budapest (HU)

(21) Appl. No.: 15/091,228

(22) Filed: Apr. 5, 2016

Related U.S. Application Data
(63) Continuation-in-part of application No. PCT/EP2015/051563, filed on Jan. 27, 2015.
Application No. PCT/EP2015/051563 is a continuation-in-part of application No. PCT/EP2016/054455, filed on Mar. 2, 2016.
(60) Provisional application No. 62/127,280, filed on Mar. 2, 2015.

(51) Int. Cl. H04L 12/24; H04L 12/26

(52) U.S. Cl. CPC H04L 41/0672; H04L 43/0811

(57) ABSTRACT

Various networks may benefit from suitable management techniques and systems. For example long term evolution networks and other wireless communication networks may benefit from a quality of experience aware transport self-organizing network framework. A method can include monitoring transport connectivity with respect to at least one base station (e.g. eNB) over a mobile backhaul. The method can also include detecting at least one degradation or anomaly in the transport connectivity of the at least one base station. The method can further include taking an appropriate network management action in response to the detected degradation or anomaly.

### CROSS-REFERENCE TO RELATED APPLICATION

This application is related as a continuation-in-part to Péter Szilágyi and Csaba Vulkán, “Context based correlated QoS measurement and QoE monitoring framework,” filed as PCT/EP2015/051563 on Jan. 27, 2015, the entirety of which is hereby incorporated herein by reference. This application is a continuation-in-part of International Patent Application No. PCT/EP2016/054455 filed on Mar. 2, 2016. This application also claims the benefit and priority of U.S. Provisional Patent Application No. 62/127,280 filed Mar. 2, 2015, the entirety of which is hereby incorporated herein by reference.

### BACKGROUND

1. Field

Various networks may benefit from suitable management techniques and systems. For example long term evolution networks and other wireless communication networks may benefit from a quality of experience aware transport self-organizing network framework.

2. Description of the Related Art

Mobile Backhaul (MBH) is a transport network that can provide connectivity among radio access network (RAN) elements, such as evolved node Bs (eNBs), serving gateways (S-GWs), mobility management entities (MMEs), and the like. For communication among such elements all traffic including user-, control- and management-plane may transferred over one or more mobile backhaul. Typically, MBHs are complex and heterogeneous systems, including multiple technology layers from multiple vendors. Also, typically MBHs span large areas, such as whole states or countries. Furthermore, typically MBHs can collect and aggregate the traffic of a whole mobile network.

The capital expenditures (CAPEX) and operating expenditures (OPEX) may be a significant share in the total cost of ownership of MBHs. Keeping these costs low mandates careful planning and reduced operation costs through automation. Nevertheless, the planning is typically a process with low accuracy as the resource need is calculated based on traffic forecasts and simplified network models. Traffic forecasts by nature are inaccurate as they are at best are based on historical measurements. Simplifications are conventionally needed to keep the numerical complexity and processing requirements at reasonably low level. During planning, the parameters and configuration of each network element can be calculated and these values are eventually downloaded to the network elements. Due to inaccurate inputs and rough models these parameters may not provide optimal system operation under traffic load.

A common characteristic of the alternative/complementary transport solutions is that in each case long-lasting transport tunnels are configured between the radio access nodes and that quality of service (QoS) schemes are applied at the packet level. When the network is extended with new eNBs, the transport tunnels can be configured either manually or via provisioning tools, which may provide some level of automation. During the provisioning process, the transport tunnels can be configured on top of the existing ones one by one, as the network is extended, having their path calculated in a locally optimal way.

The result may be suboptimal on the system level and may be inefficient compared to a case when all the existing and new transport tunnels over a system are known in advance and the configuration is calculated by considering the whole network, the total demand, the granularity of the allocations vs. the granularity of the resources and applying multi-layer optimization (MLO) techniques. The gap is increasing with the size of the transport network and the amount of configured connections, making room for significant CAPEX savings.

As discussed before, resource allocations and transport QoS parameters are statically configured using recommended values or based on the forecasted traffic. There may be no globally suitable configuration and the traffic demand may be changing dynamically. Due to the complexity of the system and the high number of parameters that must be configured in each case, reconfigurations and re-parameterizations may be executed rarely. Efficient operation may require the self-adaptation of the transport parameters to the continuously changing traffic. When the transport connectivity is provided by third parties via transport services accessed through user network interfaces (UNIs), according to the pre-agreed service level agreements (SLAB), the cost and the resource efficiency is a significant aspect upon the definition/calculation of the required transport services.

As an MBH may have a significant role in end-to-end performance, inefficient operation of an MBH can have significant negative impact on user experience. This negative user experience may affect the revenues the operators can realize. For example, poor service can lead to high churn.

Self-organizing network (SON) was successfully deployed in the long term evolution (LTE) of the third generation partnership project (3GPP). SON can reduce the risks of manual errors, enable optimal resource utilization, and lower the energy usage. The standardized SON functions can address self-healing, self-configuration and self-optimization of LTE's radio network layer.

Currently, the planning, dimensioning and commissioning of mobile networks is based on traffic forecasts done by extrapolation of traffic measurements; configuration of the planning results with static parameters; monitoring the network performance; and manual re-planning and re-configuration if needed. The validity of the configured parameters depends on the accuracy of the forecasted traffic mix and of the planning. Also, static parameters may not provide optimal operation over large enough traffic range.

eNB commissioning can be based on LTE base transceiver station (BTS) auto connectivity and LTE BTS auto configuration. The scope of these features can be to allow the eNB to connect to network management server and download configuration files. The conventional assumption is that as a result of the planning process, the transport connectivity is configured before the eNB is commissioned. Thus, the transport resources can be pre-allocated to the eNB and LTE BTS auto connectivity and LTE BTS auto configuration are not responsible for establishing and configuring the transport connectivity of the eNB whatsoever. These features are not operational if the transport configuration is not available beforehand or is not consistent. Thus, there is no true plug-and-play solution that would eliminate the need of preconfigured transport services.

### SUMMARY

A method, according to a first embodiment, can include monitoring transport connectivity with respect to at least one base station (for example, an eNB) over a mobile backhaul. The method can also include detecting at least one degradation or anomaly in the transport connectivity of the at least one base station. The method can further include taking an appropriate network management action in response to the detected degradation or anomaly.

In a variant, the appropriate network management action can include determining whether the detected degradation or anomaly is due to a local problem and, if the detected degradation or anomaly is not due to a local problem triggering a network manager.

In a variant, the appropriate network management action can include, when the detected degradation or anomaly is determined to be due to a local problem, determining whether the local problem can be resolved by reconfiguration, and reconfiguring when the local problem can be resolved by reconfiguration.

In a variant, the appropriate network management action can include, when the detected degradation or anomaly is determined to be due to a local problem that cannot be resolved by reconfiguration, sending an alarm or report to an operation support system.

In a second embodiment, a method can include monitoring mobile backhaul transport related triggers with respect to at least one base station (for example, an eNB). The method can also include detecting whether a degradation or anomaly corresponding to the triggers is persistent. The method can further include taking an appropriate network management action in response to the detected degradation or anomaly.

In a variant, the method can further include at least one of filtering, correlation, or severity level evaluation of the triggers.

In a variant, when the degradation or anomaly is not persistent, the appropriate network management action can include entering a monitoring mode with respect to the triggers.

In a variant, when the degradation or anomaly is persistent, the appropriate network management action can include determining whether the degradation or anomaly can be resolved by a manager.

In a variant, when the degradation or anomaly cannot be resolved by a manager, the appropriate network management action can include sending an alarm to an operation support system.

In a variant, when the degradation or anomaly can be resolved by a manager, the appropriate network management action can include initiating reconfiguration.

In a variant, the reconfiguration can be conditional on receiving approval from an operator.

According to third and fourth embodiments, an apparatus can include means for performing the method according to the first and second embodiments respectively, in any of their variants.

According to fifth and sixth embodiments, an apparatus can include at least one processor and at least one memory and computer program code. The at least one memory and the computer program code can be configured to, with the at least one processor, cause the apparatus at least to perform the method according to the first and second embodiments respectively, in any of their variants.

According to seventh and eighth embodiments, a computer program product may encode instructions for performing a process including the method according to the first and second embodiments respectively, in any of their variants.

According to ninth and tenth embodiments, a non-transitory computer readable medium may encode instructions that, when executed in hardware, perform a process including the method according to the first and second embodiments respectively, in any of their variants.

According to tenth and eleventh embodiments, a system may include at least one apparatus according to the third or fifth embodiments in communication with at least one apparatus according to the fourth or sixth embodiments, respectively in any of their variants.

### BRIEF DESCRIPTION OF THE DRAWINGS

For proper understanding of the invention, reference should be made to the accompanying drawings, wherein:

FIG. 1 illustrates a Tra-SON architecture according to certain embodiments.

FIG. 2 illustrates an extended Tra-SON architecture, according to certain embodiments.

FIG. 3 illustrates implementation alternatives of an eNB-side TSA according to certain embodiments.

FIG. 4 illustrates operation of the TSA according to certain embodiments.

FIG. 5 illustrates Tra-SON manager interworking according to certain embodiments.

FIG. 6 illustrates transport service optimization by a manager based on a TSA trigger, according to certain embodiments.

FIG. 7 illustrates an example decision by a manager, according to certain embodiments.

FIG. 8 illustrates another example decision by a manager, according to certain embodiments.

FIG. 9 illustrates resolution of degradation caused by a poorly configured transport device, according to certain embodiments.

FIG. 10 illustrates optimization of system level resource allocations, according to certain embodiments.

FIG. 11 illustrates a system according to certain embodiments.

### DETAILED DESCRIPTION

Certain embodiments introduce self-organizing networks (SON) to mobile backhaul (MBH) for example to reduce OPEX and to increase the resource usage efficiency that reduces the CAPEX, as well as for other purposes. More particular, certain embodiments provide a SON framework over MBH that, through enhanced optimization and automation techniques, can increase the level of automation, simplify the planning and configuration process, and maximize the efficiency of the network.

Certain embodiments can apply to LTE and 3G MBH. Due to the similarities, the discussion below is addressed to LTE. The same techniques and features, however, can be directly applied to 3G shared (3G and LTE) environments. Other modifications and adjustments are also permitted.

Certain embodiments may address various issues. For example, certain embodiments can address increased system complexity, such as a large amount of network elements, complex topologies, multi-technology environment in the MBH that means that the system is difficult to dimension, commission and manage.

Furthermore, certain embodiments can address a complex and dynamic traffic mix that may not be handled efficiently with static parameter sets. For example, certain embodiments can address a situation in which there is no globally valid configuration that could be downloaded to each network element. Furthermore, certain embodiments may address situations in which adaptive and context specific parameterization is needed.

Certain embodiments can address inaccurate planning that is based on traffic forecast and simplified network models. Even the most accurate traffic forecast may become obsolete quickly. In order to prevent the planning, not only the configurations but the physical capacity and the resource allocation) from obsolescence, over-dimensioning can be provided in certain embodiments.

Certain embodiments may also address situations in which there is not aligned transport and radio QoS. The former can be aggregate centric, whereas the latter can be bearer centric. Upon transport congestion, the end-to-end QoS targets may not met. Certain embodiments can address such QoS shortfall issues.

Furthermore, certain embodiments can address issues related to time consuming, failure prone node, network commissioning, operation, and management. Likewise, certain embodiments can address the need for rapid delivery of mobile services, including coverage, connectivity, capacity, and access to applications.

Certain embodiments introduce a solution that can extend SON, including self-healing, self-configuration, and self-optimization, to the MBH. Thus, certain embodiments can increase automation, can simplify the planning and commissioning process, can harmonize transport and radio QoS, can increase system efficiency, can reduce total cost of ownership (TCO), can provide valuable insight during trouble shooting, can reduce energy consumption, and can keep the resource allocations at a system level optimum.

The scope of the transport SON (Tra-SON) framework can include increasing the level of automation within the Mobile Backhaul (MBH) by applying true plug-and-play, self-configuration and self-optimization mechanisms. The operation of the framework can rely on advanced key performance indicator (KPI) collection, anomaly and degradation detection mechanisms, and network management solutions such as software defined networking (SDN). Tra-SON can enable simplified planning and minimum touch commissioning, as well as automated and adaptive network operation.

Certain embodiments may guarantee efficient network resource utilization, harmonization of the radio and transport quality of service (QoS) architectures and quality of experience (QoE) driven operation. Moreover, certain embodiments may provide a significantly reduced CAPEX and OPEX. Certain embodiments may be versatile and capable of working in a multivendor radio access (RA) environment and/or an MBH environment. While the operation of certain embodiments is explained over Long Term Evolution (LTE), certain embodiments are also directly applicable to 3G/high speed packet access (HSPA) systems as well.

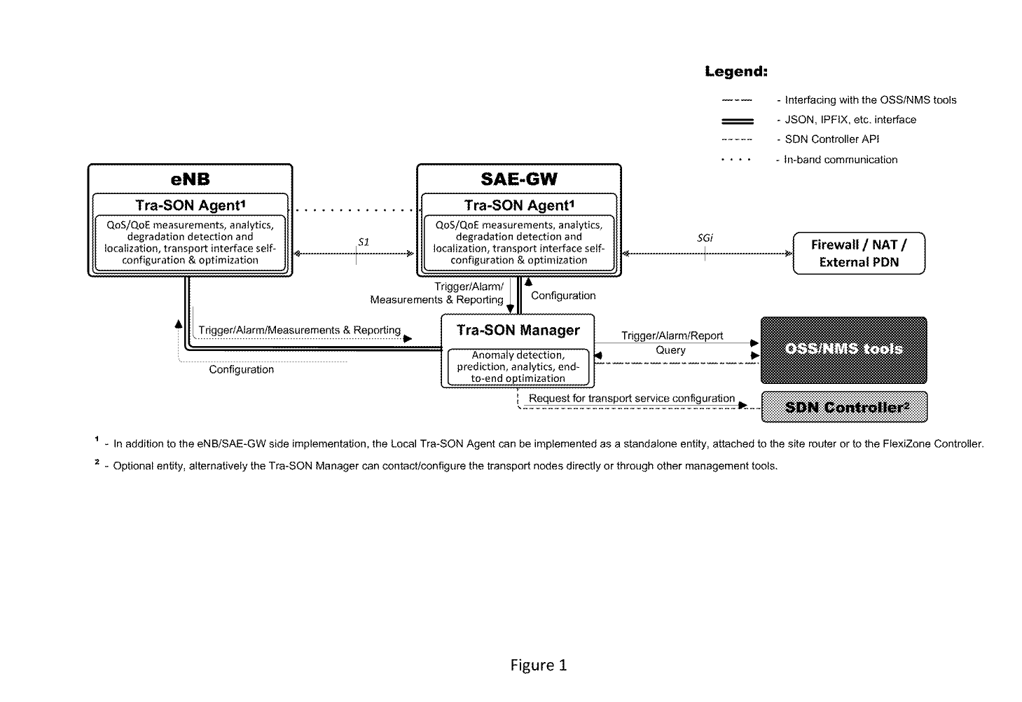

FIG. 1 illustrates a Tra-SON architecture according to certain embodiments. As shown in FIG. 1, in certain embodiments, Tra-SON agents can be deployed at the eNB and/or S-GW and/or SAE-GW. Furthermore, a Tra-SON manager can be located in a core network.

A Tra-SON agent, whether in an eNB or in an SAE-GW, can perform QoS/QoE measurements and provide analytics, degradation detection and localization, as well as transport interface self-configuration and optimization. The Tra-SON agent can also be configured to receive configuration information from a Tra-SON manager and provide triggers, alarms, measurements, and other reporting to the manager. The Tra-SON manager can be configured for anomaly detection, prediction, and analytics, and end-to-end optimization. The Tra-SON manager can be configured to send triggers, alarms and reports to an OSS/NMS server and to send a request for transport service configuration to an SDN controller.

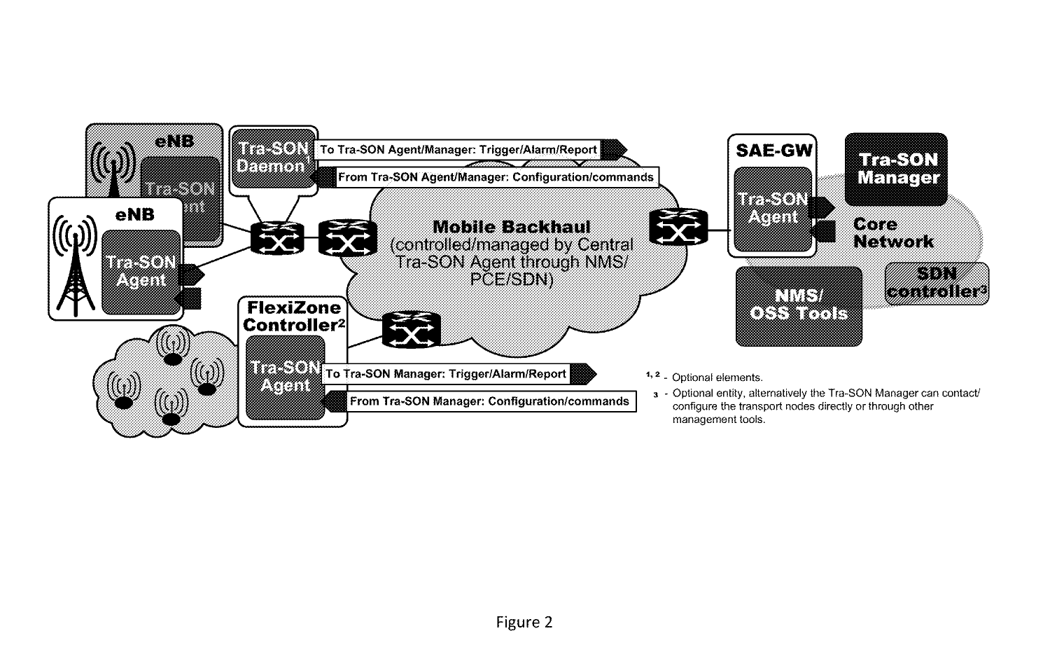

FIG. 2 illustrates an extended Tra-SON architecture, according to certain embodiments. For example, the architecture can be extended with Tra-SON agents deployed at a FlexiZone Controller if there is a micro/pico mesh within the system, and/or Tra-SON Daemons installed on top of selected transport devices. The Tra-SON elements can have various roles and functionalities.

For example, an eNB side Tra-SON agent (TSA) can be a software entity running on or attached to an eNB as a site device. The role of the TSA can be to maintain a harmonized QoS over the RA system and a consistent end-to-end transport configuration. Additionally, the eNB side TSA can be responsible to complete the commissioning of the eNB by creating and configuring the transport connectivity of the eNB. In similar manner, the TSA can detect an automated neighbor relation (ANR) originated activation/configuration of an X2 interface and can automatically establish the corresponding transport connectivity.

In order to detect any anomaly and degradation on the transport layer, or for other reasons, the TSA can monitor and profile all the traffic of the eNB. When an anomaly/degradation is detected, the TSA can first identify the reason of the degradations, initially separating radio and transport side problems. In case the problems are rooted in the transport network, the TSA can further localize the problematic transport segment. Finally, if needed (for example, in order to resolve the degradation or to maintain the QoS) the TSA can perform or trigger reconfigurations and/or optimizations. The reconfigurations can target the transport interface, the site router of the eNB, if such a device exists, or the end-to-end transport service.

TSA can be a measurement point that extracts real time QoS and QoE KPIs and intercepts/detects relevant events from/within the user, control and management plane traffic of the eNB. Moreover, the TSA can monitor the control plane traffic/messages of the transport network in order to detect any relevant change in the status of the network/link/path, or the like. The anomaly detection and localization procedures used by the TSA can employ the mechanisms described in “Context based correlated QoS measurement and QoE monitoring framework,” filed as PCT/EP2015/051563 on Jan. 27, 2015. The TSAs can communicate with each other and the Tra-SON Manager through in-band, such as header enrichment, or out of band (for example, JSON/IPFIX) interfaces. Depending on the implementation, such as residing agent in a network element, a standalone box, or the like, the TSA can use internal interfaces for eNB side transport configuration or legacy management interfaces such as SNMP, CLI, etc.

The S-GW/SAE-GW side TSA can be a software entity running on or attached to an S-GW/SAE-GW. The S-GW/SAE-GW side TSA can act as a counterpart of the eNB side TSAs, with similar role with these. Through cooperative measurements with the eNB side TSAs, the S-GW/SAE-GW side TSA can provide an efficient framework for anomaly/degradation detection and localization.

A FlexiZone Controller side TSA can have similar functionality to the other TSAs, that is, as being located at the termination of the S1 interface serving the micro-mesh, it is responsible of managing the corresponding transport connectivity. Due to the similarities, this option is not discussed further on within this Invention Report but is mentioned as a valid use case.

The Tra-SON manager can be a software entity that can either be attached to an existing OSS tool in form of a content pack or can be running on a standalone node. The manager can act as a system level optimization and configuration entity that is responsible for resolving degradations that are related to the end-to-end transport service or are affecting multiple network elements, for example, congestion on a transport link shared by the traffic of multiple eNBs.

Additionally, the manager can be responsible for trend analysis and prediction based on the relevant KPIs collected by the TSAs. Such a role can allow preventive operation, such as triggering reconfiguration before the negative tendencies would cause hard failures. The KPIs collected by the TSAs can be upstreamed to the manager through out-of-band interfaces such as JSON or IPFIX, depending on the use case, in a raw or processed/aggregated format.

Also, the TSAs can trigger the manager whenever a detected anomaly cannot be resolved through local configuration or it is due to a problem with the transport service, for example where is not a proper resource allocation. The TSAs can also trigger the manager when a detected anomaly is clearly within the MBH, and consequently may affect other eNBs as well.

The manager can collect these triggers, can consolidate the triggers to filter out false positives (or for other reasons), and can finally correlate the triggers to identify incidents reported by distinct TSAs that are caused by the same failure/problem. The manager can operate in real time, implementing a closed control loop, for example as an entity that resolves single or transient incidents on the MBH, and/or through a long control loop, for example as an entity that resolves persistent degradations or prevents failures caused by negative trends.

Additionally, the manager can be configured to proactively configure the system to follow the typical traffic profile of the eNBs and the shifting load between network domains, which may be caused by the mobility routing of the users. In addition to resolving transient or pathological failures, the manager can be responsible for maintaining system efficiency and keeping the system operation and resource usage/allocations at an optimal working point. Accordingly, in addition of being triggered by the TSAs, the manager can trigger actions by itself whenever the manager detects inefficient resource usage/allocation or system operation by analyzing the collected KPIs.

To accomplish such self-triggering (or for other reasons), the manager can be integrated with existing OSS and customer experience management (CEM) tools and can have access to the KPI database of such tools. Depending on the environment, such as the existence of SDN controller, PCE or other transport provisioning tool, the manager can either directly connect to some or all the transport nodes through the existing/standard management and configuration interfaces or can act as a user of the SDN controller, PCE or other transport provisioning tool.

In the following discussion, the operation of the manager is explained as an application running as a client of an SDN controller. Nevertheless, similar operation is also possible and permitted in case of a PCE or any other provisioning/transport management tool. Moreover, if the reach of an SDN controller is limited to a certain domain, or there are several SDN controllers managing distinct network domains, the manager can act as integrator. For example, the manager can trigger reconfiguration or optimization by separately addressing the individual SDN controllers or even directly configuring the network elements out of the reach of the SDN controller(s) in order to achieve a coherent end-to-end system configuration/status. The integration of the Manager to the OSS ecosystem may permit reporting of the actual network status, distribution of the special KPIs collected by the Tra-SON infrastructure, and/or issuing alarms in case of problems/failures that cannot be solved by the manager. For example, the manager may not be able to provide required capacity extension.

An optional Tra-SON daemon can be a software entity running on the transport nodes. The daemon can act as a KPI collection point capable of detecting anomalies The daemon can also act as a measurement point participating in the collaborative measurements thus allowing more accurate anomaly/failure localization. The daemon can further act as a KPI source that can transfer the collected raw or aggregated KPIs to the manager over standard management interfaces. Additionally, the daemon can act as an entity that executes the configuration commands issued by the manager or a master TSA of the daemon.

It is not mandatory to install the daemon at all. If, for example due to MBH specifics, the daemon can add value to the operation of the Tra-SON framework, still it is not mandatory to install the daemon to each and every transport node. Instead, the daemon may be installed to select transport nodes, such as those acting as ingress/egress nodes between distinct network domains or those that are aggregating the traffic of a high number of eNBs.

The transport SON framework according to certain embodiments can be used in various ways. For example, in a first use case the transport SON framework according to certain embodiments can be used for plug and play eNB commissioning. This use case can simply the transport planning to a great extent and can increase the level of automation of the eNB commissioning process. The current eNB commissioning requires that transport services are pre-planned and pre-configured before the provisioning process. In contrast, transport SON framework according to certain embodiments can eliminate the need of pre-planning and pre-configuring the transport connectivity of each and every eNB. The eNB side TSA can detect the start of the commissioning process and can automatically trigger the transport configuration through the manager. By the time the first user plane connection is established the transport connectivity may be available. As a second step, the transport SON framework according to certain embodiments can optimize the resource allocation of the eNB to the traffic demand the eNB serves.

In a second use case, the transport SON framework according to certain embodiments can be used for automated transport configuration for the X2 interface as a complementary mechanism to the ANR. In a similar manner to the use case described above, the Tra-SON framework can be configured to detect the newly activated/established X2 interfaces and configure the transport connectivity in an optimal manner, such as a reduced number of hops, efficient resource allocation, or the like.

In a third use case, the transport SON framework according to certain embodiments can be used for eNB and/or SAE-GW transport interface and transport router self-configuration and parameter optimization. This use case may not only simplify the planning and configuration process but may also enable harmonized radio and transport QoS and may guarantee coherent end-to-end transport configuration. Through the TSAs, the Tra-SON can enable the dynamic and adaptive configuration of the transport parameters that best serve a given actual traffic mix. Accordingly, the TSAs can monitor the traffic in order to detect if a target QoS is not met. The reason why the target QoS may not be met may be, for example, due to the radio and transport configuration not being harmonized. The TSAs can also monitor the traffic in order to detect if the configured resources are not sufficient for proper QoS. Whenever such cases of QoS shortfall or resource shortage are detected, the TSAs can automatically reconfigure the relevant transport parameters as a self-configuring process or can trigger the manager for action, for example in case the problem cannot be solved through local reconfiguration. This use case may allow the deployment of network elements with default configuration, as the solution itself can take care that the best parameters for a given eNB are found.

In a fourth use case, the transport SON framework according to certain embodiments can provide transport service self-optimization. The Tra-SON can be capable of detecting if a transport service is not configured with the optimal resource allocation and can trigger a reconfiguration. Accordingly, the TSAs trigger the Manager in case the detected degradation is due to poor transport service configuration. As a result, the manager can select one of the following actions. For example, the manager can increase of the bandwidth allocation in case of enough free resources on the existing path. In another option, in case of not enough transport resources, the manager can identify the underutilized transport services that are sharing the same resources with the one having not enough bandwidth allocation, and can downsize the underutilized transport services to make room for extending the allocation of the problematic transport service. In another option, the manager can reroute transport services and at the same time can maintain even load and optimal system resource utilization, for example in case there are not enough resources on the path of the congested transport service and there is no possibility to free up enough bandwidth by downsizing other services. According to a further option, the manager can trigger the operator with an alarm message coupled with recommended configuration in case none of the above actions are possible.

In a fifth use case, the transport SON framework according to certain embodiments can detect transport elements that are not properly configured. For example, the TSA(s) can continuously perform end-to-end measurements. Thus, the transport elements that have a configuration that degrades the QoS or the system efficiency can be detected. Depending on the set-up, the manager may be configured to identify these elements and correct the configuration of these elements.

In a sixth use case, the transport SON framework according to certain embodiments can perform traffic trend analysis and preventive optimization. For example, the manager can continuously monitor the traffic in order to detect traffic trends and to identify the potential future resource limitations/narrow points within the system. As a result, the manager can update the system configuration to prevent these incidents. In order to leverage the gain of the geographical diversity and the daily commuting routine of the users, whenever the topology allows it, the manager can free up resources allocated to serve the suburban cells and can increase the resource allocation of the downtown areas, or the like, during the business hours and can revert the configuration after the business hours are over. Moreover, the manager may be capable of delaying the reconfiguration in order to avoid preventing planned network extensions or to operate based on allocation and retention priorities, cost functions, or the like.

In a seventh use case, the transport SON framework according to certain embodiments can maintain optimal system level configuration and resource allocation. Upon network deployment, when the system is extended upon the commissioning of eNBs, the system state can drift from the optimal status as transport resources are provisioned one-by-one to the new eNBs. This may be because the transport services of a newly provisioned eNB can be created by considering the actual status, namely the already configured services and the resource need of the new transport services being established. This approach can provide a local optimum. As the number of newly configured eNBs increases, this approach may lead to suboptimal configuration at a system level. The manager can continuously monitor the existing allocations, such as resource allocations vs. available capacity, the paths of the transport tunnels vs. the topology, and so on. When enough gain can be achieved by a system level optimization, for example when more than a threshold amount of gain can be so achieve, the manager can calculate the optimal path for each service by considering the system level optimum, can create a step-wise plan for reconfiguration, and can trigger the reconfiguration(s) according to this plan.

In an eighth use case, the transport SON framework according to certain embodiments can include SLA monitoring. The Tra-SON framework can be used in order to monitor the SLA, in case the transport services are provided over leased lines; to identify underutilized resources; and/or to predict resource limitations, as well as to quantify the required resources.

In a ninth use case, the transport SON framework according to certain embodiments can be used for measurements, for example of KPIs. The Tra-SON framework can act as a measurement mechanism that can provide detailed and accurate KPIs as well as identify and localize failures. Thus, certain embodiments can improve network monitoring, management and troubleshooting capabilities.

The above use cases can be performed individually or in combination with one other. These are simply example use cases, with other uses also being permitted.

The Tra-SON can operate over heterogeneous MBH environments. There may be a variety of possible implementations, of which the following are some examples.

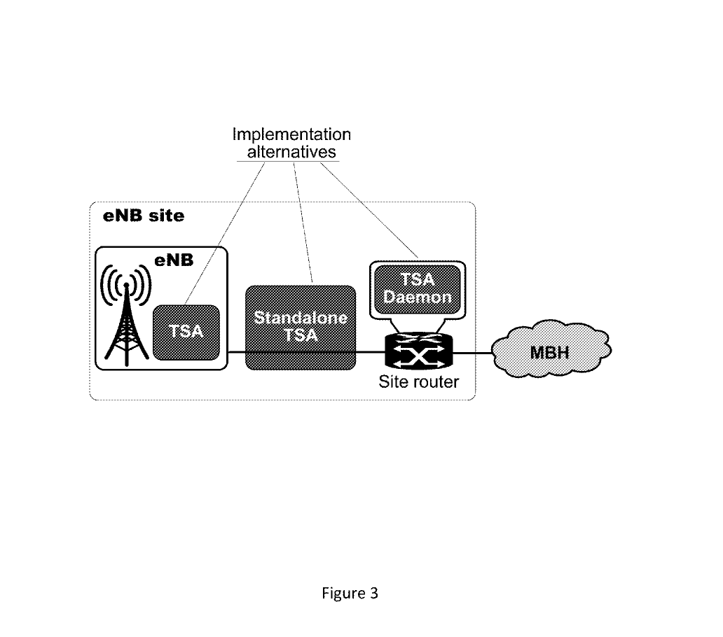

FIG. 3 illustrates implementation alternatives of an eNB-side TSA according to certain embodiments. A valid implementation of the eNB side TSA can include a software entity running on the eNB itself or on a standalone device located at the eNB site or on a site router. The latter implementation can correspond to a TSA daemon. A possible implementation of the daemon is to deploy the daemon over router SDKs if such is available. In each implementation alternative, the TSA can be an in-line entity that is able to monitor the whole traffic of the eNB, including for example user-, control-, management-plane traffic.

The TSA can manage transport connectivity of the eNB during its whole lifetime as follows. In case it is a software entity running on the eNB, the TSA can use an internal management interface to configure the eNBs transport interface card, and a common management interface, such as SNMP, Netconf, CLI, or the like, to manage the site router, if there is such element on the site. In case TSA is a standalone entity, the TSA can use the available management interfaces to configure the relevant transport parameters of the eNB and those of the site router. In a third alternative, the daemon can manage the site router through an internal interface. In each case, the TSA can have access to the QoS parameters of the eNB that are used as input to the self-configuration/self-optimization processes. A further valid alternative is to delegate all the management responsibilities to the manager that is configuring/optimizing the eNB side transport parameters through the SDN controller (for example via an open flow southbound interface) or by an existing common management interfaces (such as SNMP, Netconf, CLI, or the like.). In this alternative, the TSA can act as a KPI collection and analytics entity that is triggering the manager for actions in case an anomaly is detected.

When the eNB is commissioned, the TSA that monitors the whole traffic of the eNB can detect that the commissioning process was started and can extract a tracking area code (TAC) and the relevant transport configuration parameters, such as VLAN IDs and the like, from a configuration file that the eNB downloads from the management server, such as a NetAct entity. This may be possible when the commissioning file is not encrypted.

An alternative method is that the eNB can inform the TSA about the TAC and other relevant information. This may be useful when the commissioning file is encrypted. Yet another valid alternative is that the TSA can detect the commissioning process itself and can inform the manager about the commissioning process. This alternative may be useful when the TSA is not running on the eNB. These are implementation alternatives. In general, the transport connectivity can be created during the commissioning process by the Tra-SON framework, thus increasing the level of automation regardless the specific implementation.

The extracted, or otherwise obtained, information can be forwarded to a manager that is configured to maintain a database of the S-GWs assigned to each TAC. This information can be acquired from the NetAct and can be continuously updated. Alternatively or additionally, if the list of S-GWs is provided as part of the configuration file, which may be an optional feature, the TSA can also extract this information and forwards this information to the manager. Based on the information received, the manager can establish transport connectivity through existing network management tools, such as SDN Controller, PCE, or the like. If such network management tools are not available, the manager can execute the configuration by itself.

For example, first the manager can allocate an initial bandwidth to the transport service created for the newly commissioned eNB with a value that can be set as the average resource allocation of the eNBs already operating in the surrounding area. Once the eNB starts to operate, for example when user traffic appears at the transport layer, the TSA can start monitoring and profiling in order to adjust the bandwidth allocation to the traffic demand

The commissioning process can be considered as completed by the eNB and the NetAct when the manager informs those elements that the transport connectivity was established. In case the TSA is implemented with the capability to detect the commissioning process only, the manager may acquire the required information from the NetAct. A valid alternative implementation is, as part of the commissioning process, for the NetAct to trigger the Manager to create the required connectivity. This is operation may correspond to the first use case described above.

In a similar way, the TSA can detect the activation of a new X2 interface, in case the ANR is turned on. Once the corresponding procedure is detected, the TSA can trigger the manager to create the required connectivity between the involved eNBs. The manager can establish the transport connectivity for the X2 interface (for example, a point-to-point tunnel) by considering the optimal resource utilization over the MBH and the special X2 requirement, such as shortest path between the eNBs in terms of a minimum number of intermediate transport hops. The resource allocation can be done in similar way as in the case of the eNB commissioning process: first the manager can allocate resources by considering the resources allocated to the already established X2 interfaces, followed by the monitoring and continuous adaptation process to the traffic needs and trends. The TSA can detect if an X2 is not used anymore and can trigger the manager to release the allocated resources. This can be implementation of the operation of the second use case referenced above.

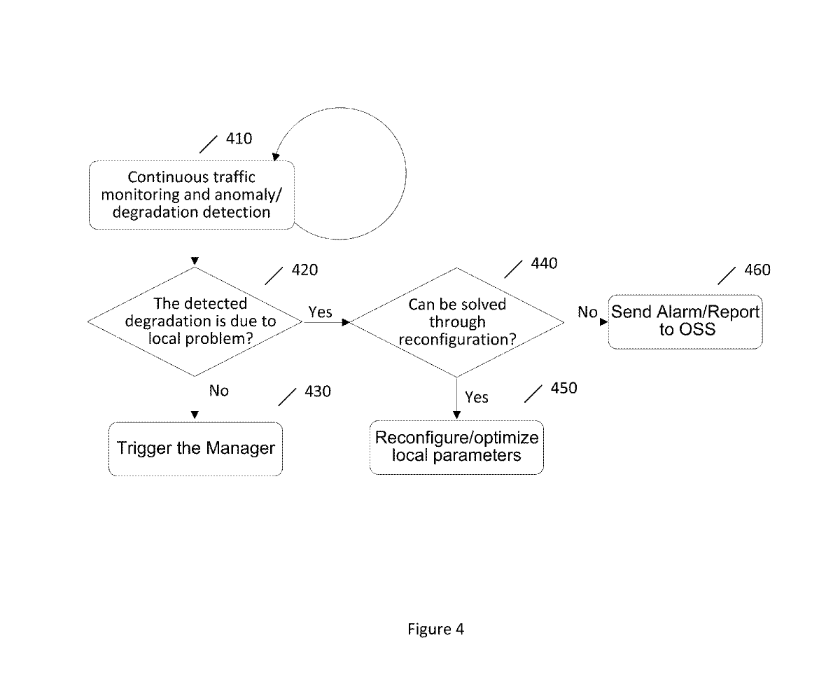

FIG. 4 illustrates operation of the TSA according to certain embodiments. As mentioned above, the TSA can employ the mechanisms described in “Context based correlated QoS measurement and QoE monitoring framework,” filed as PCT/EP2015/051563 on Jan. 27, 2015, for anomaly and degradation detection and localization. Additionally, the TSA can, at 410, continuously monitor the level of QoS provided to the bearers to detect any deviation from the expected behavior caused by, for example, transport layer issues such as poor configuration, resource limitation, or the like. Whenever a degradation or deviation from the target QoS is detected, at 420 the TSA can localize the problem. For example, the TSA can check whether the problem is due to the eNBs transport interface or to the site router. In case the problem is local, the TSA can at 440 check whether this problem can be solved through reconfiguration and can, at 450, initiate the needed reconfiguration or optimization. The locally configurable parameters can include the scheduling weights, RED/AQM parameters, shaping rates and shaper parameters, and the like. If the problem is local but is due to a problem that can't be solved by parameter reconfiguration, at 460 the TSA can issue an alarm to the OSS. If the degradation is caused by the end-to-end transport connectivity (for example, not enough physical capacity, congested transport or transport service with low bandwidth allocation, or the like) at 430 the TSA can trigger the manager for action. This is can provide an implementation of operation of the Tra-SON framework according to third use case mentioned above.

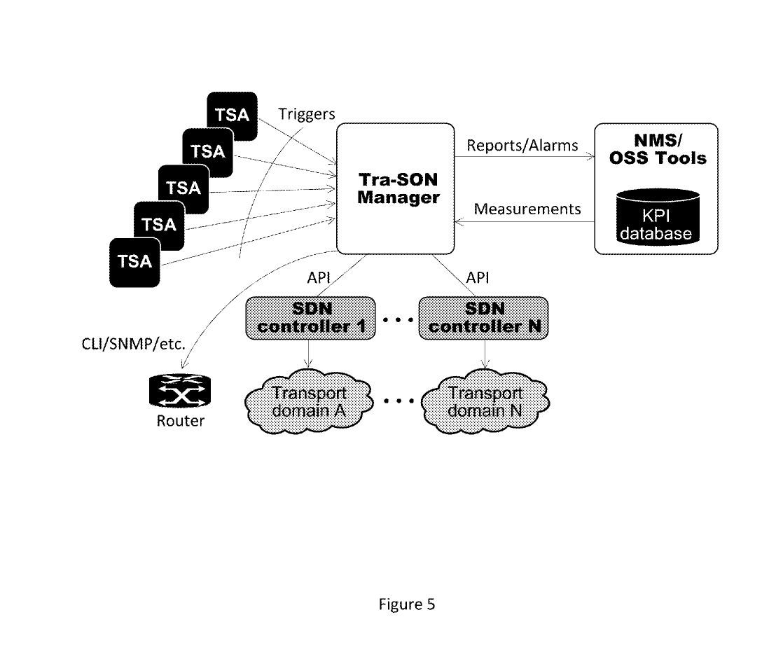

FIG. 5 illustrates Tra-SON manager interworking according to certain embodiments. As shown in FIG. 5, the TSA can act as a measurement/KPI collection point that is capable to upstream the collected KPIs in raw or aggregated format to the manager or the OSS tools.

A valid implementation of the S-GW/SAE-GW/FlexiZone Controller TSA can include, for example, a software entity running on the FlexiNG/FlexiZone controller or a standalone entity at the FlexiNG/FlexiZone controller site or as a daemon running on the site router(s). In each case the TSA can have access to the whole MBH traffic of the S-GW/SAE-GW/FlexiZone controller. The rest of the functionality and operation of the TSA can be similar to the one described in case of eNB side TSA.

A valid implementation of the Tra-SON Manager can include a software entity running on a standalone server located in the Core Network or attached to an existing network management tool, such as, for example, a NetAct content pack.

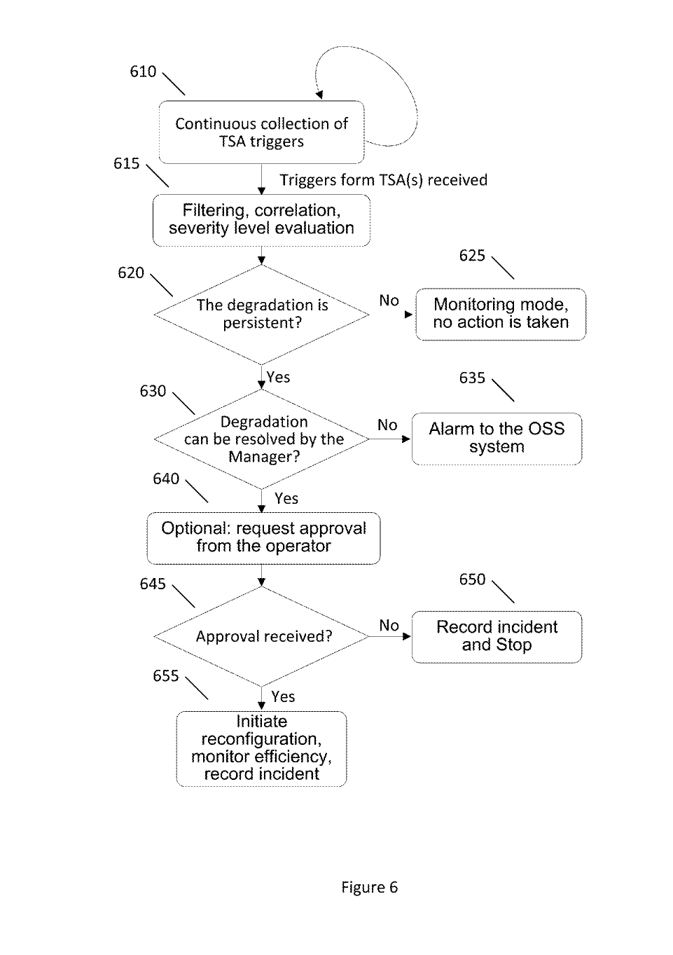

FIG. 6 illustrates transport service optimization by a manager based on a TSA trigger, according to certain embodiments. As shown in FIG. 6, a manager can act as a network level manager/optimizer that is taking actions either based on the triggers received from the TSAs or whenever it detects suboptimal system configuration or, based on the trend analysis the manager executes, it predicts degradation.

The manager can be connected to each TSA within the network via a management interface such as JSON, IPFEX, or the like. This interface can be used by the TSAs to trigger the manager when degradation is detected that cannot be solved by local reconfiguration or parameter optimization, as mentioned above.

At 610 these triggers are collected and, at 615, filtered by the manager in order to remove the false positive alarms and finally correlated in order to identify those failures/degradations that are affecting multiple eNBs. Once the correlated list of failures/degradation is available, the manager can first evaluate their severity level, for example the amount of affected eNBs, affected services, transient degradation vs. persistent one, and so on. Severe failures/degradations, such as those that are determined to be persistent at 620, can be handled first by identifying the possible actions, checking the available resources and triggering the required reconfiguration/optimization. In case of reasons such as resource limitation degradation that are determined not to be able to be resolved by the manager at 630, an alarm can be sent to the OSS system/operator at 635.

At 625, transient degradation may not be resolved through action but may be monitored to detect if the transient issue turns into a persistent issue. If the degradation can be resolved, the manager can evaluate the required action (for example, amount of extra resources, new configuration of the affected network elements, alternative path, and the like) and can, at 640, issue a request to the transport management/configuration tools, for example to an SDN controller.

In case the MBH includes multiple domains managed by distinct SDN controllers and resolving the degradation requires changes in multiple domains, the manager can orchestrate the reconfiguration by sending domain specific requests to the corresponding SDN controllers. In case there are network elements not being managed by any of the existing SDN Controllers, or there are no SDN controller domains within the MBH nor is any other management tool available, the manager can use the available management and control interfaces (for example, SNMP, Netconf, CLI, or the like) or the daemon if available to enforce the required actions.

A valid alternative is that the manager can assume responsibility for configuring the transport parameters of eNB/S-GW/SAE-GW/FlexiZone Controller/site router. In this case, once a trigger is received from the TSA for such action, or the manager itself detects a degradation caused by these network elements, the manager can identify the required action, define the new configuration, and originate the reconfiguration either through the corresponding SDN controller, if the network elements are managed by an SDN controller, or through the use of an available management interface such as SNMP, Netconf, CLI, or the like.

After the request, the manager can determine at 645 whether approval was received. If it was not received, the manager can record the incident at 650. When approval is received, the manager can initiate reconfiguration, monitor efficiency, and record the incident at 655. Thus, the Tra-SON framework can be deployed to enable the operator to follow, monitor and even to approve/reject the actions originated/proposed by the framework. These procedures can correspond to the fourth use case discussed above.

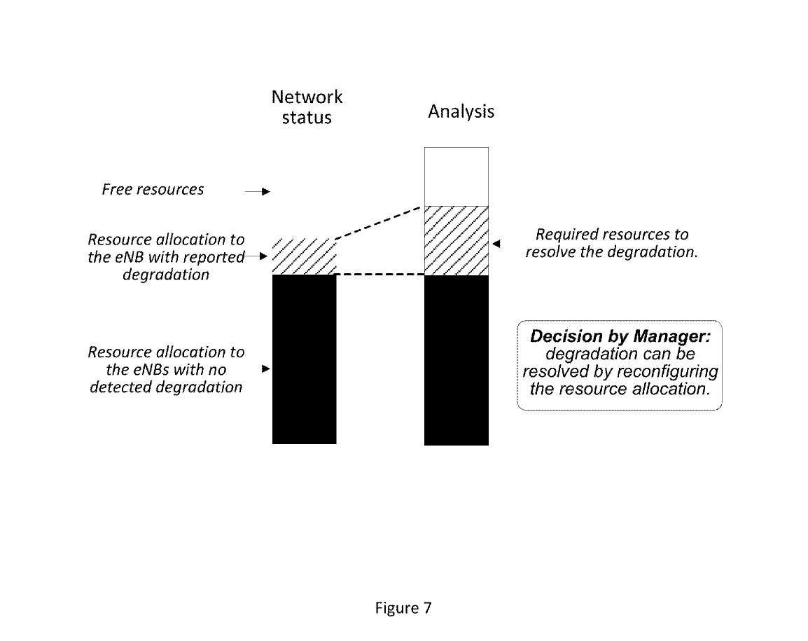

FIG. 7 illustrates an example decision by a manager, according to certain embodiments. As discussed above, before resolving the degradation, the manager can identify the required action, can calculate the resource(s) need (for example, if the problem is rooted in resource allocation) and can evaluate whether there are enough free resources end-to-end. One possible outcome of the evaluation/analysis is that there are enough free resources on each link of the end-to-end path, as illustrated in FIG. 7. In this case, the manager can initiate an increase of the resource allocation through the SDN controller(s) and/or provisioning tools or can execute the reconfiguration directly, for example when a network domain/elements is not managed by an SDN controller or any other suitable tool. It should be noted that in each case the resource need can be calculated based on the KPIs collected by the TSAs using enhanced analytics methods.

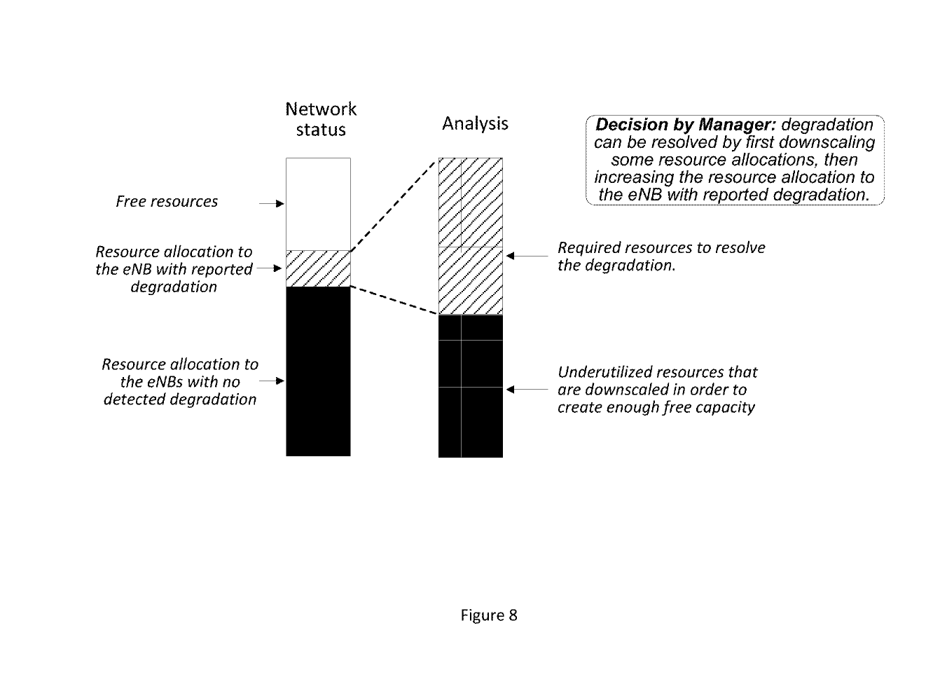

FIG. 8 illustrates another example decision by a manager, according to certain embodiments. If there is not enough resources end-to-end, the manager can look for possible alternative actions. One possibility is that there can be other transport services sharing the same resources with the service for which the degradation was detected, that are underutilized. Therefore, the manager can identify the services that are sharing resources with the one that has resource limitation and can check their level of utilization using historical data collected through the TSAs. If there are enough underutilized resources that could be reallocated, the manager can resolve the degradation in two steps: first, the resource allocation of the underutilized transport services can be downscaled and second, the resource allocation of the eNB with degradation can be increased.

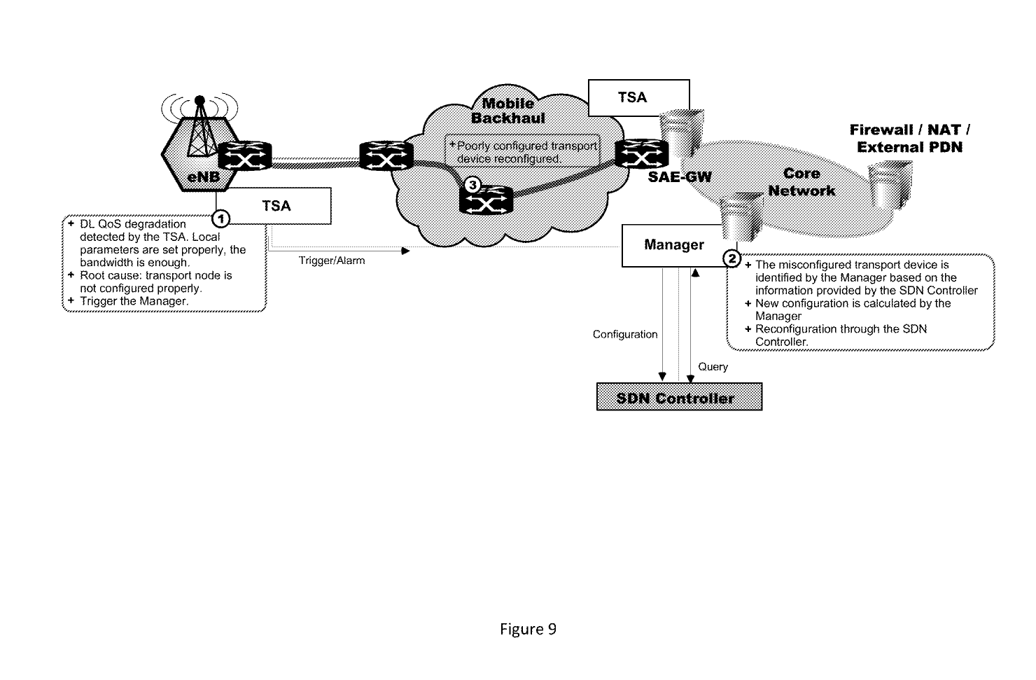

FIG. 9 illustrates resolution of degradation caused by a poorly configured transport device, according to certain embodiments. In case there are no underutilized transport services that could be downscaled in order to solve the degradation, the manager can try to find an alternative path for the service where enough free resources are available. If such a path exists, the manager can reroute the service and can increase the resource allocation over the new path. Alternatively, the manager can create free resources by rerouting services that are not having resource problem and can keep the problematic service at its original path. This action can be taken when the action preserves the system operation at optimal level.

In addition to resource limitations, poorly configured transport nodes can also cause efficiency or QoS/QoE degradation. The anomaly/degradation detection and problem localization run by the TSAs can detect the existence of such network elements. If such elements are detected at 1 in FIG. 9, the TSA can trigger the manager for actions by providing the relevant context as well. The manager can, at 2, identify the poorly configured transport node with the help of the SDN controller and can initiate the reconfiguration. This operation of the Tra-SON framework can correspond to the fifth use case discussed above.

A manager can use KPIs and the results of the analytics collected/run by the TSAs, or received from common OSS KPI databases, for trend detection and overall system efficiency evaluation. Based on the available information the manager can detect alarming trends that may eventually lead to degradation or suboptimal system operation. Additionally, the manager can analyze the daily profiles (for example, including traffic, user demand, resource need, or the like) of the eNBs to identify potential sources of geographical diversity or daily resource need.

Geographical diversity may permit the manager to dynamically shift resources from for example suburbs to downtown or business areas and back as the users start to commute from their homes to their workplaces. The daily traffic pattern of an eNB can be used to release unused resources and allocate only as much as is appropriate for a proper service level at an eNB at a given period of the day. In this way, the daily routine of the users can be followed and significant resource and energy consumption gains/savings can be achieved, provided that the infrastructure allows it.

Accordingly, based on the results of trend analysis, the manager can initiate the required configurations to prevent negative trends from culminating in degradations/failures or poor network performance. In case there are capacity limitations that prevent these actions, the manager can issue a warning to the OSS tools/operator. If the topology allows harvesting the geographical diversity, for example if suburban and downtown cells are sharing common transport links, the manager can initiate the desired dynamic configuration according to the learned traffic patterns/profiles/demand. Finally, the manager can increase/decrease the resource allocation according to the daily profile of the eNBs. This can correspond to operation according to the sixth use case mentioned above.

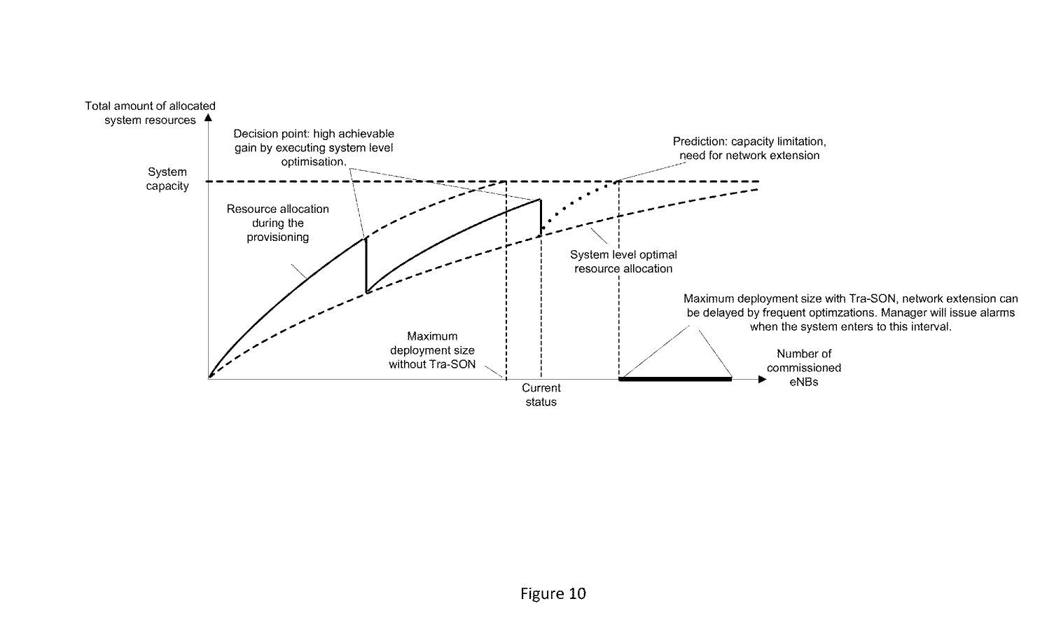

FIG. 10 illustrates optimization of system level resource allocations, according to certain embodiments. As shown in FIG. 10, a manager can periodically check the system status, such as topology vs. resource allocations, in order to detect if the system is not in the optimal state. As typically new resources are provisioned as the network is extended as part of the eNB commissioning process, the resource allocation mechanisms starting point can be the network topology, available resources, already provisioned services and the requirements on the new services, such as protection, disjointness criteria, or the like.

The use of initial provisioning criteria may cause only locally optimal configuration to be achieved as the resources are provisioned one-by-one. The overall system status may increasingly drift from the system level optimum. Therefore, when the system analysis run by the manager shows significant gain of running a system level optimization, the manager can initiate a step-wise reconfiguration process, where first the optimal path for each service is calculated then the required intermediate configuration steps are also identified in order to allow the migration of the services without interruption.

This reconfiguration plan can be executed automatically or under the supervision of the operator that can approve/reject parts or the complete plan. This handling of the plan can be done by transferring the plan to the OSS tools where it can be visualized. This mechanism can lead to significant efficiency gains as shown in FIG. 10. In order to achieve such gains, the Manager can run a multi-layer optimization (MLO) program that optimizes the MBH resource allocations by considering all the transport technology layers (for example, optical, Ethernet, IP-MPLS, and so on. This can be the manager's operation under the seventh use case described above.

When the transport services are provided through leased lines, the Tra-SON framework can operate as described above except that the manager may not be able to trigger end-to-end service reconfiguration by itself but can act as SLA monitoring tool, that, based on the measurements collected through the TSA can evaluate if the leased line SLAs are met. This evaluation can be used to identify those leased lines that are underutilized and those that should have more bandwidth allocation, or to detect if due to a misconfiguration at the leased line service provider the end-to-end QoS is not met. These operations can correspond to the operations of the eighth use case described above.

The Tra-SON framework can serve as an efficient mechanism of collecting deep insight on the network performance and efficiency where the TSAs are acting as measurement and anomaly detection points that can provide accurate and detailed KPIs, incident reports, root causes, and the like to the OSS system. In this case, the manager can collect the measurements, run additional analytics on the KPIs, and transfer the data to the relevant OSS databases. Thus, this can correspond to some possible implementations of the ninth use case mentioned above.

Currently, there are no solutions on the market that are able to efficiently implement the use cases provided by the Tra-SON framework. By contrast, certain embodiments can provide simplified plug and play eNB service, on-demand X2 service creation, QoE driven transport network reconfiguration, radio/transport QoS harmonization, and the like. For example, in certain embodiments operation can be provided across heterogeneous MBH equipment deployments or over devices that are not manageable via an SDN controller, using, for example, a daemon aided implementation.

Furthermore, certain embodiments can provide for intelligent MBH configuration actions, such as proactive or reactive action to QoE degradation, daily traffic fluctuations, longer term trends, automated parameter tuning, and the like. These may be provided via an insight driven MBH management system, which can obtain the measurements, insight, analytics, profiling, anomaly detection capabilities from the TSA and the manager as described above.

A self-configuring MBH may be able to respond to a deliberately misconfigured parameter (for example, a parameter configured in a way that creates imbalanced radio and transport QoS settings) by automatically tuning the relevant parameter(s) back to their optimal value, in accordance with the third use case mentioned above.

Likewise, certain embodiments may provide for modification of the transport service of an eNB without a detectable change in the eNB's own traffic profile. Such a modification may be accomplished via execution of a system level reconfiguration or re-distribution of resources to another eNB requiring more resources, as described in the fourth use case mentioned above.

In certain embodiments, agents can communicate between the TSAs and the manager using packets on the relevant interfaces, such as the S1 interface. Traffic can also be exchanged between the manager and the OSS/NetAct tools, for example, when integration is not implemented via an internal interface.

Various embodiments may have benefits or advantages. For example, in certain embodiments there may be an always on mechanism that can continuously monitor the network status through user and control plane KPIs (for example, direct and derived/constructed ones) in a holistic way (for example, not the individual values against a predefined threshold but their level/constellation/pattern/evolution within the context of the system status against the profiled behavior) to detect any anomaly and to define if an anomaly means degradation. In the latter case, yet another proprietary method can be used in order to identify those degradations that are transport related (for example, congestion, short buffer, path switch, wrong network node parameterization, or the like) followed by an as accurate as possible localization, such as location to, for example, transport interface of RA nodes, site router, leased line or transport service. Once the transport degradation, its location, and reason have been identified, a mechanism can be applied to identify the required action, such as to calculate the needed resources and check if that is available at the relevant network domain, and automatically execute it. SDN is one example of a possible tool for implementation. The framework can be capable of doing the management action by itself, through any existing management platform such as SDN.

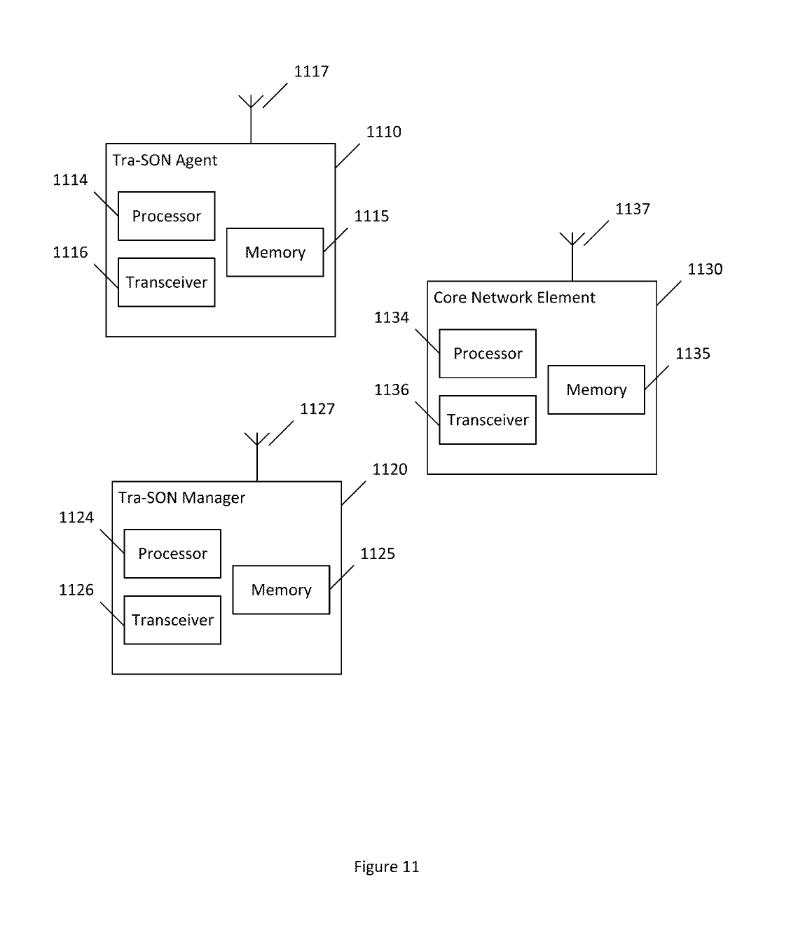

FIG. 11 illustrates a system according to certain embodiments of the invention. In one embodiment, a system may include multiple devices, such as, for example, at least one Tra-Son agent 1110 which may be provided in an evolved Node B, SAE-GW, or as a standalone device, at least one Tra-SON manager 1120, and at least one core network element 1130, which may be an SDN controller or a server configured to provide OSS/NMS tools, or the like.

Each of these devices may include at least one processor, respectively indicated as 1114, 1124, and 1134. At least one memory can be provided in each device, and indicated as 1115, 1125, and 1135, respectively. The memory may include computer program instructions or computer code contained therein. The processors 1114, 1124, and 1134 and memories 1115, 1125, and 1135, or a subset thereof, can be configured to provide means corresponding to the various blocks of, for example, FIGS. 4, 6, and 9.

As shown in FIG. 11, transceivers 1116, 1126, and 1136 can be provided, and each device may also include an antenna, respectively illustrated as 1117, 1127, and 1137. Other configurations of these devices, for example, may be provided. For example, core network element 1130 may be configured for wired communication, instead of wireless communication, and in such a case antenna 1137 can illustrate any form of communication hardware, without requiring a conventional antenna.

Transceivers 1116, 1126, and 1136 can each, independently, be a transmitter, a receiver, or both a transmitter and a receiver, or a unit or device that is configured both for transmission and reception.

Processors 1114, 1124, and 1134 can be embodied by any computational or data processing device, such as a central processing unit (CPU), application specific integrated circuit (ASIC), or comparable device. The processors can be implemented as a single controller, or a plurality of controllers or processors.

Memories 1115, 1125, and 1135 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as Tra-SON agent 1110, Tra-SON manager 1120, and core network element 1130, to perform any of the processes described herein (see, for example, FIGS. 4, 6, and 9). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 11 illustrates a system including a Tra-SON agent, Tra-SON manager, and core network element, embodiments of the invention may be applicable to other configurations, and configurations involving additional elements. For example, not shown, additional Tra-SON Agents may be present, and additional core network elements may be present, as illustrated in FIGS. 1 and 2, for example.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

ANR Automated Neighbor Relation

AQM Active Queue Management

BTS Base Transceiver Station

CAPEX Capital Expenditures

CEM Customer Experience Management

CLI Command Line Interface

E2E End-to-End

eNB evolved Node B

FlexiNG Flexi Network Gateway

GW Gateway

HSPA High Speed Packet Access

JSON JavaScript Object Notation

KPI Key Performance Indicator

LTE Long Term Evolution

MBH Mobile Backhaul

MLO Multi-Layer Optimization

NAT Network Address Translation

OPEX Operation Expenditures

OSS Operation Support System

PCE Path Computation Element

QoE Quality of Experience

QoS Quality of Service

RA Radio Access

RED Random Early Detection

SDN Software Defined Networking

SAE-GW System Architecture Evolution Gateway

SDK Software Development Kit

S-GW Serving Gateway

SLA Service Level Agreement

SNMP Simple Network Management Protocol

SON Self Organizing Network

TAC Tracking Area Code

Tra-SON Transport SON

TSA Tra-SON Agent

We claim:

1. A method, comprising:
monitoring transport connectivity with respect to at least one base station over a mobile backhaul;
detecting at least one degradation or anomaly in the transport connectivity of the at least one base station; and
taking an appropriate network management action in response to the detected degradation or anomaly.

2. The method of claim 1, wherein the at least one base station comprises an evolved Node B.

3. The method of claim 1, wherein the appropriate network management action comprises determining whether the detected degradation or anomaly is due to a local problem and, if the detected degradation or anomaly is not due to a local problem triggering a network manager.

4. The method of claim 1, wherein the appropriate network management action comprises, when the detected degradation or anomaly is determined to be due to a local problem, determining whether the local problem can be resolved by reconfiguration, and reconfiguring when the local problem can be resolved by reconfiguration.

5. The method of claim 1, wherein the appropriate network management action comprises, when the detected degradation or anomaly is determined to be due to a local problem that cannot be resolved by reconfiguration, sending an alarm or report to an operation support system.

6. A method, comprising:
monitoring mobile backhaul transport related triggers with respect to at least one base station;
detecting whether a degradation or anomaly corresponding to the triggers is persistent; and
taking an appropriate network management action in response to the detected degradation or anomaly.

7. The method of claim 6, wherein the at least one base station comprises an evolved Node B.

8. The method of claim 6, further comprising:
at least one of filtering, correlation, or severity level evaluation of the triggers.

9. The method of claim 6, wherein, when the degradation or anomaly is not persistent, the appropriate network management action comprises entering a monitoring mode with respect to the triggers.

10. The method of claim 6, wherein, when the degradation or anomaly is persistent, the appropriate network management action comprises determining whether the degradation or anomaly can be resolved by a manager.

11. The method of claim 6, wherein, when the degradation or anomaly cannot be resolved by a manager, the appropriate network management action comprises sending an alarm to an operation support system.

12. The method of claim 6, wherein, when the degradation or anomaly can be resolved by a manager, the appropriate network management action comprises initiating reconfiguration.

13. The method of claim 12, wherein the reconfiguration is conditional on receiving approval from an operator.

14. An apparatus, comprising:
at least one processor; and
at least one memory including computer program code,
wherein the at least one memory and the computer program code are configured to, with the at least one processor, cause the apparatus at least to
monitor transport connectivity with respect to at least one base station over a mobile backhaul;
detect at least one degradation or anomaly in the transport connectivity of the at least one base station; and
take an appropriate network management action in response to the detected degradation or anomaly.

15. The apparatus of claim 14, wherein the at least one base station comprises an evolved Node B.

16. The apparatus of claim 14, wherein the appropriate network management action comprises determining whether the detected degradation or anomaly is due to a local problem and, if the detected degradation or anomaly is not due to a local problem triggering a network manager.

17. The apparatus of claim 14, wherein the appropriate network management action comprises, when the detected degradation or anomaly is determined to be due to a local problem, determining whether the local problem can be resolved by reconfiguration, and reconfiguring when the local problem can be resolved by reconfiguration.

18. The apparatus of claim 14, wherein the appropriate network management action comprises, when the detected degradation or anomaly is determined to be due to a local problem that cannot be resolved by reconfiguration, sending an alarm or report to an operation support system.

19. An apparatus, comprising:
at least one processor; and
at least one memory including computer program code,
wherein the at least one memory and the computer program code are configured to, with the at least one processor, cause the apparatus at least to
monitor mobile backhaul transport related triggers with respect to at least one base station;
detect whether a degradation or anomaly corresponding to the triggers is persistent; and
take an appropriate network management action in response to the detected degradation or anomaly.

20. The apparatus of claim 19, wherein the at least one base station comprises an evolved Node B.

21. The apparatus of claim 19, wherein the at least one memory and the computer program code are configured to, with the at least one processor, cause the apparatus at least to perform at least one of filtering, correlation, or severity level evaluation of the triggers.

22. The apparatus of claim 19, wherein, when the degradation or anomaly is not persistent, the appropriate network management action comprises entering a monitoring mode with respect to the triggers.

23. The apparatus of claim 19, wherein, when the degradation or anomaly is persistent, the appropriate network management action comprises determining whether the degradation or anomaly can be resolved by a manager.

24. The apparatus of claim 19, wherein, when the degradation or anomaly cannot be resolved by a manager, the appropriate network management action comprises sending an alarm to an operation support system.

25. The apparatus of claim 19, wherein, when the degradation or anomaly can be resolved by a manager, the appropriate network management action comprises initiating reconfiguration.

26. The apparatus of claim 25, wherein the reconfiguration is conditional on receiving approval from an operator.
